(19) United States
(12) Patent Application Publication
(10) Pub. No.: US 2013/0201091 A1
(43) Pub. Date: Aug. 8, 2013

(54) THREE-DIMENSIONAL DISPLAY

(71) Applicant: Innolux Corporation, Miao-Li County (TW)

(72) Inventor: Chia-Liang Hung, Miao-Li County (TW)

(73) Assignee: INNOLUX CORPORATION, Miao-Li County (TW)

(21) Appl. No.: 13/744,450

(22) Filed: Jan. 18, 2013

(30) Foreign Application Priority Data
Feb. 6, 2012 (TW) 101103820

(51) Int. Cl. G02B 27/22; G09F 13/04

(52) U.S. Cl. CPC G02B 27/22; G09F 13/04
USPC 345/102; 362/97.1

(57) ABSTRACT

A three-dimensional display includes a display module, a back light module (BLU) and a barrier module. The barrier module disposed above the display module includes a first substrate, a second substrate and a display material sandwiched therebetween. The first substrate has a first electrode layer which includes plural first wide and narrow electrodes interlaced in order, and plural first gaps turned on between adjacent first wide and narrow electrodes. The second substrate has a second electrode layer including plural second wide and narrow electrodes interlaced in order, and second gaps turned on between adjacent second wide and narrow electrodes. The second narrow electrodes are positioned correspondingly to the first wide electrodes, while the second wide electrodes are positioned correspondingly to the first narrow electrodes. The first and second electrode layers are driven to present barrier patterns in the odd frames and even frames, respectively.

This application claims the benefit of Taiwan application Serial No. 101103820, filed Feb. 6, 2012, the subject matter of which is incorporated herein by reference.

### BACKGROUND

1. Technical Field

The disclosed embodiments relate in general to a three-dimensional (3D) display, and more particularly to a naked eye 3D display with high display resolution and low crosstalk interference.

2. Description of the Related Art

Displays such as liquid crystal displays (LCDs) have been developed to provide three-dimensional (3D) displays in various forms and ranging from experimental displays in university departments to commercial products. Currently, most of 3D displays require the use of special headgear or glasses on the part of the viewer. Due to inconveniency of the use of headgear or glasses, many manufacturers have been studied and advanced towards the technology of autostereoscopic display.

Autostereoscopic displays, also known as “Naked eye 3D display”, are able to provide binocular depth perception without the hindrance of specialized headgear or filter/shutter glasses. Naked eye 3D displays have been demonstrated using a range of optical elements in combination with an LCD including parallax barrier technology and lenticular optic technology to provide stereoscopic vision. Generally, the parallax barrier has optical apertures aligned with columns of LCD pixels, and the lenticular optics has cylindrical lenses aligned with columns of LCD pixels. A parallax barrier could be a sheet or an electro optic panel with fine slits to separate the light pathway of spatial images into images for left eye and right eye, and this reconstructed scene of the left eye image and right eye image is perceived as 3D images by the observer. FIG. 1 is a conventional 3D display with parallax barrier. A parallax barrier 15 is positioned in front of a display panel 11, and between human eyes and the display panel 11. The backlight module 13 emits light. The parallax barrier 15 with transparent and opaque strips limits the pixels only radiate light in directions seen by the left eye or right eye. In the accurate alignment between the backlight module 13 and the display panel 11, the left eye and the right eye of the observer would receive images on the odd numbered pixels and even numbered pixels, respectively. When different images are presented on the odd numbered pixels and even numbered pixels of the display panel 11 and received by the left eye and the right eye correspondingly, it is capable of conveying depth perception to the viewer and providing stereoscopic vision by fooling the human brain. Alternatively, the parallax barrier 15 could be positioned behind the display panel 11, and between the backlight module 13 and the display panel 11. The transparent and opaque strips of the parallax barrier 15 are still able to partially block the light emitted from the backlight module 13 and only transparent strips allow penetration of light, thereby achieving the naked eye 3D displaying effect.

Generally, the naked eye 3D display possesses 2D/3D switchable function. To switch the 2D mode and 3D mode of display, the pattern of transparent and opaque interlaced strips of the parallax barrier 15 as shown in FIG. 1 has to disappear. Most of the 2D/3D switchable 3D displays adopt an electro optic panel with fine and vertical stripes as a barrier module. When the display is in 2D mode, the barrier module is turned off to allow the full penetration of the light from the backlight module. When the display is in 3D mode, the barrier module reveals the pattern of transparent and opaque interlaced strips.

One example of the barrier modules for providing parallax view includes a liquid crystal layer sandwiched between a thin film transistor (TFT) substrate and a color filter (CF) substrate, and polarizers are attached at outer sides of the TFT and CF substrates. Generally, the transparent electrodes of the TFT and CF substrates are a stripe-interlaced pattern of ITO and a complete plane of ITO, respectively. When a common voltage applied to the transparent electrode of the CF substrate is sustained while different voltages are applied to the transparent electrode of the TFT substrate, the liquid crystal molecules is reoriented (e.g. twisted/untwisted/switched) in proportion to the voltage applied, and the varying degrees of the liquid crystal molecules allow or block the light to pass through; therefore, this barrier module with voltage applied is able to alternately present the pattern of black-and-white interlaced stripes and pattern of white-and-black interlaced stripes after the light passes through the barrier module. The following drawings depict part of the electrodes of the TFT and CF substrates for illustration.

FIG. 2A and FIG. 2B illustrate part of electrodes of TFT and CF substrates of a barrier module displaying an odd numbered frame of a conventional 3D display, respectively. When the barrier module displays an odd numbered frame, the regions 201 and 203 of the electrode of the TFT substrate as shown in FIG. 2A are respectively applied with a white-state voltage and a dark-state voltage (and the electrode of the CF substrate as shown in FIG. 2B is applied with a common voltage) to show the regions 201 and regions 203 being transparent and dark, so as to make the barrier module present the pattern of white-and-black interlaced stripes.

FIG. 3A and FIG. 3B illustrate part of electrodes of TFT and CF substrates of a barrier module displaying an even numbered frame of a conventional 3D display, respectively. When the barrier module displays an even numbered frame, the regions 201 and 203 of the electrode of the TFT substrate as shown in FIG. 3A are respectively applied with a dark-state voltage and a white-state voltage (and the electrode of the CF substrate as shown in FIG. 3B is applied with a common voltage) to show the regions 201 and regions 203 being dark and transparent, so as to make the barrier module present the pattern of black-and-white interlaced stripes.

The conventional design as illustrated above is to form the stripe-shaped electrodes on one side of the substrate of the barrier module while the other side of the substrate including a complete surface of the electrode. In order to acquire the same visual effects on the left and right sides along the x-direction, it is designed that the widths of the stripe-shaped electrodes are the same and the adjacent electrodes are spaced apart by intervals for receiving electric signals independently. In a normally white LC mode, the electrodes with the same widths brings the drawback of the white region wider than the dark region because no sufficient electrical field occurs to drive and change the state of LC molecules at the intervals between the adjacent electrodes. As shown in FIG. 2A, the width Wc of the white region in the odd numbered frame is equal to the width of the transparent region 201 and the widths Sc of two lateral intervals, while the width Dc of the dark region is equal to the width of the region 203, and Wc is larger than Dc (Wc>Dc). As shown in FIG. 3A, the width Wc of the white region in the even numbered frame is also larger than the width Dc of the dark region after pattern alternately changed to black-and-white interlaced stripes. However, the design of white regions larger than dark regions would increase the visible crosstalk along the x-direction of the 3D image.

### SUMMARY

The disclosure is directed to a three-dimensional (3D) display with a barrier module functioning as parallax barrier, and both substrates of the barrier module have finger-shaped electrodes. The electrodes of the top and lower substrates are staggered from each other. The electrode design enlarges the dark regions in the odd and even numbered frames, thereby decreasing the visible crosstalk interference of the 3D image without sacrificing the resolution of 3D display.

According to one aspect, a 3D display is provided, comprising a display module, a back light module, and a barrier module disposed above the display module. The barrier module comprises a first substrate, a second substrate and a display material sandwiched between the first substrate and the second substrate. The first substrate has a first electrode layer comprising a plurality of first wide electrodes and a plurality of first narrow electrodes interlaced in order, and a plurality of first gaps are formed between the adjacent first wide electrodes and first narrow electrodes. The second substrate is assembled to the first substrate and has a second electrode layer. The second electrode layer comprises a plurality of second wide electrodes and a plurality of second narrow electrodes interlaced in order, and a plurality of second gaps are formed between adjacent second wide electrodes and second narrow electrodes. Also, the second narrow electrodes of the second electrode layer are positioned correspondingly to the first wide electrodes of the first electrode layer, while the second wide electrodes of the second electrode layer are positioned correspondingly to the first narrow electrodes of the first electrode layer.

According to another aspect, a displaying method of the 3D display described above is provided. When the display module displays an odd numbered frame, a first dark-state voltage is applied to the first wide electrodes and a first white-state voltage is applied to the first narrow electrodes of the first electrode layer of the first substrate, and a common voltage is applied to the second electrode layer of the second substrate. When the display module displays an even numbered frame, a second dark-state voltage is applied to the second wide electrodes and a second white-state voltage is applied to the second narrow electrodes of the second electrode layer of the second substrate, and the common voltage is applied to the first electrode layer of the first substrate.

### BRIEF DESCRIPTION OF THE DRAWINGS

FIG. 1 (prior art) is a conventional 3D display with parallax barrier.

FIG. 2A (prior art) and FIG. 2B (prior art) illustrate part of electrodes of TFT and CF substrates of a barrier module displaying an odd numbered frame of a conventional 3D display, respectively.

FIG. 3A (prior art) and FIG. 3B (prior art) illustrate part of electrodes of TFT and CF substrates of a barrier module displaying an even numbered frame of a conventional 3D display, respectively.

FIG. 4A illustrates a three-dimensional (3D) display with a barrier module displaying an odd numbered frame according to one of the embodiments of the present disclosure.

FIG. 4B is a top view of part of the electrode of the first substrate of the barrier module of FIG. 4A.

FIG. 5A illustrates a three-dimensional (3D) display with a barrier module displaying an even numbered frame according to one of the embodiments of the present disclosure.

FIG. 5B is a top view of part of the electrode of the second substrate of the barrier module of FIG. 5A.

FIG. 6 illustrates a displaying method of the 3D display with a flash-type BLU according to one embodiment of the present disclosure.

FIG. 7A and FIG. 7B illustrate a displaying method of the 3D display with a scanning-type BLU in one odd numbered frame and one even numbered frame according to a further embodiment of the present disclosure, respectively.

FIG. 8A and FIG. 8B illustrate a displaying method of the 3D display with a scanning-type barrier module in one odd numbered frame and one even numbered frame according to another embodiment of the present disclosure, respectively.

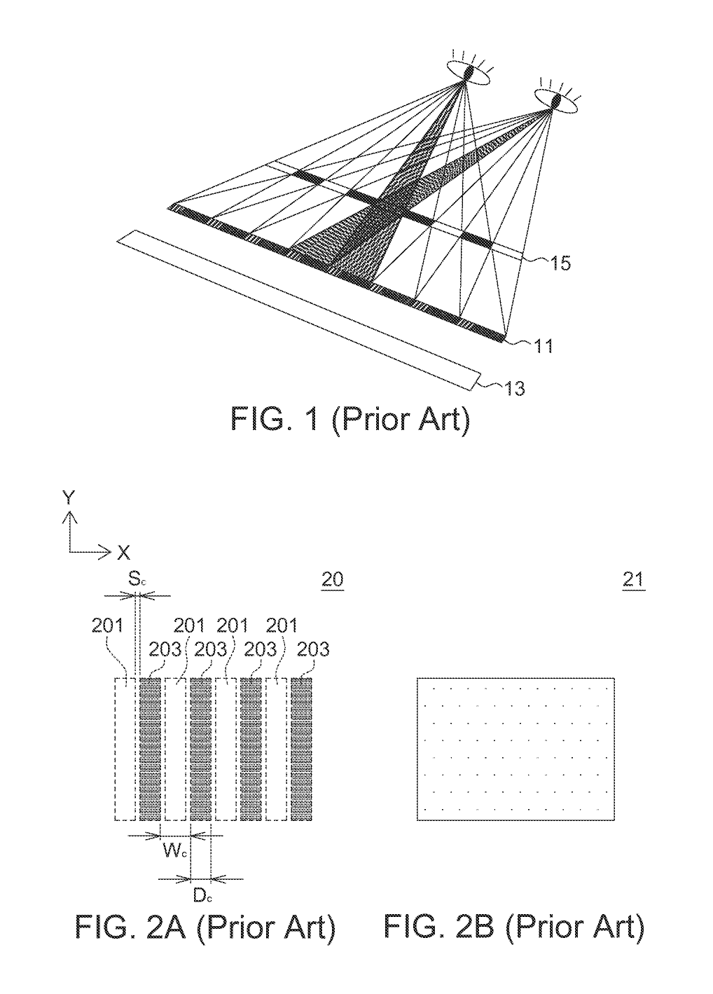

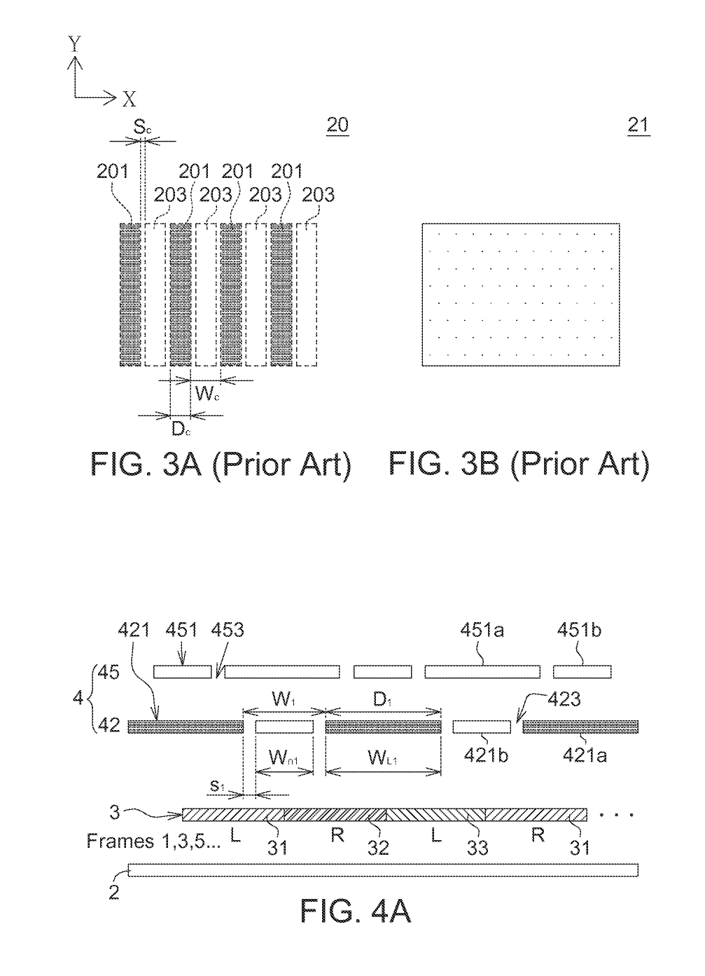

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The embodiment provides a three-dimensional (3D) display, which each of two substrates of the barrier module has electrodes with different widths to enlarge the dark regions in the odd and even numbered frames, thereby decreasing the visible crosstalk interference of the 3D image without sacrificing the resolution of 3D display. The embodiments are described in details with reference to the accompanying drawings. The details of the embodiment are provided for illustration, not intended to limit the 3D display of the present disclosure. Also, it is also important to point out that the illustrations may not be necessarily be drawn to scale, and that there may be other embodiments of the present disclosure which are not specifically illustrated. Thus, the specification and the drawings are to be regard as an illustrative sense rather than a restrictive sense.

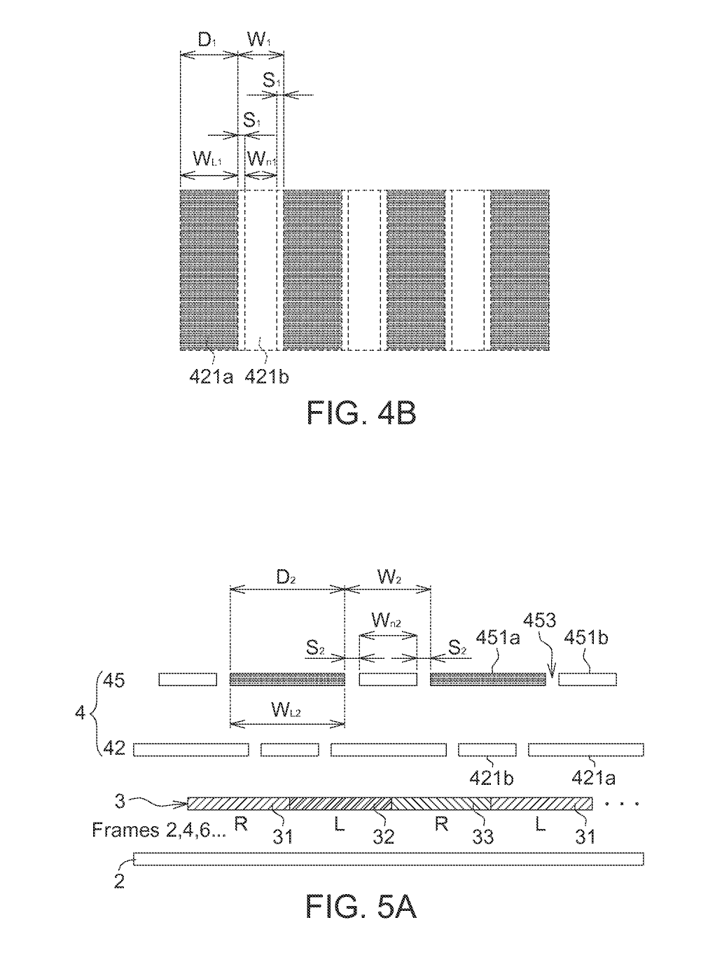

FIG. 4A illustrates a three-dimensional (3D) display with a barrier module displaying an odd numbered frame according to one of the embodiments of the present disclosure. FIG. 4B is a top view of part of the electrode of the first substrate of the barrier module of FIG. 4A. As shown in FIG. 4A, the 3D display includes a display module 3, a back light module 2 and a barrier module 4. The display module 3 comprises a plurality of sub-pixels, such as red sub-pixels 31, green sub-pixels 32 and blue sub-pixels 33. The display module 3 displays a plurality of full frames of display images, and each frame is split into 2 fields, called odd and even fields. Thus, combination of an odd numbered frame and an even numbered frame creates a full frame of display image. The back light module 2 is disposed below the display module 3 for providing light to the display module 3. In this embodiment, the barrier module 4 having 3D parallax function is disposed in front of the display module 3. The barrier module 4 includes a first substrate 42, a second substrate 45, a display material (not shown in FIG. 4A, and one example of display materials is TN-type liquid crystal molecules) sandwiched between the first substrate 42 and the second substrate 45, polarizers (not shown, and one example is a pair of crossed polarizers with orthogonal axes) attached at outer sides of the first substrate 42 and the second substrate 45, and driving units (not shown). The first substrate 42 and the second substrate 45 could be a thin film transistor (TFT) substrate and a color filter (CF) substrate, respectively.

In this embodiment, the first substrate 42 has a first electrode layer 421 comprising a plurality of first wide electrodes 421a and a plurality of first narrow electrodes 421b interlaced in order. The first wide electrodes 421a are connected to each other outside the displaying area, and so do the first narrow electrodes 421b. The first wide electrodes 421a and the first narrow electrodes 421b are electrically connected to different driving signal sources (not shown), respectively. The first wide electrodes 421a and the first narrow electrodes 421b could be made of transparent materials, such as indium tin oxide (ITO), indium zinc oxide (IZO), etc. Also, a first gap 423 is formed between the adjacent first wide electrode 421a and the first narrow electrode 421b. Those first gaps 423 are used for isolating the driving signals to the first wide electrodes 421a and the first narrow electrodes 421b. In one example, width S1 of the first gap 423 could be in a range of 1 um˜10 um, approximately.

The second substrate 45 assembled to the first substrate 42 has a second electrode layer 451. Similarly, the second electrode layer 451 comprises a plurality of second wide electrodes 451a and a plurality of second narrow electrodes 451b interlaced in order. The second wide electrodes 451a are connected to each other outside the displaying area, and so do the second narrow electrodes 451b. The second wide electrodes 451a and the second narrow electrodes 451b are electrically connected to different driving signal sources (not shown), respectively. The second wide electrodes 451a and the second narrow electrodes 451b could be made of transparent materials, such as ITO, IZO, etc. Also, a second gap 453 is formed between the adjacent second wide electrode 451a and the second narrow electrode 451b. Those second gaps 453 are used for isolating the driving signals to the second wide electrodes 451a and the second narrow electrodes 451b. In one example, width S2 of the second gap 453 could be in a range of 1 um˜10 um, approximately.

Positions of the second narrow electrodes 451b are corresponding to positions of the first wide electrodes 421a, and the boundaries of the second narrow electrodes 451b are not projected over the boundaries of the first wide electrodes 421a. Similarly, positions of the second wide electrodes 451a are corresponding to positions of the first narrow electrodes 421b, and the boundaries of the first narrow electrodes 421b are not projected over the boundaries of the second wide electrodes 451a. Also, the boundaries of the first wide electrodes 421a and the second wide electrodes 451a are overlapped.

In the embodiment, it is assumed that the display module 3 is designed with a working mode of TN-LC (Twisted Nematic) Normally White. As shown in FIG. 4A and FIG. 4B, when the display module 3 displays an odd numbered frame, a first dark-state voltage is applied to the first wide electrodes 421a, and a first white-state voltage (such as Vcom) is applied to the first narrow electrodes 421b of the first electrode layer 421 of the first substrate 42, while a common voltage (such as Vcom) is applied to the second electrode layer 451 of the second substrate 45. In this way of electrode design and voltage application, the states of LC molecules positioned above the first wide electrodes 421a are changed, and the first wide electrodes 421a become the dark regions since no light could pass through those areas. Meanwhile, the states of LC molecules positioned above the first narrow electrodes 421b and the first gaps 423 are not changed, and the first narrow electrodes 421b and the first gaps 423 form the white regions because of light penetration through those regions. It is noted that the width of the dark region is larger than the width of the white region. In this embodiment, when the display module 3 displays the odd numbered frames such as frames 1, 3, 5, . . . , etc., the barrier module 4 presents the pattern of black-and-white interlaced stripes, and the left eye (L) and right eye (R) of a viewer is able to see the appropriate images respectively on the red sub-pixel 31 and the green sub-pixel 32, or images respectively on the blue sub-pixel 33 and the red sub-pixel 31, through the barrier module 4.

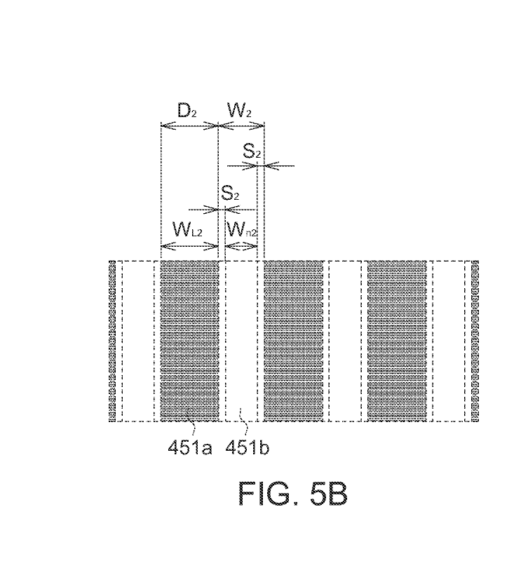

FIG. 5A illustrates a three-dimensional (3D) display with a barrier module displaying an even numbered frame according to one of the embodiments of the present disclosure. FIG. 5B is a top view of part of the electrode of the second substrate of the barrier module of FIG. 5A. It is assumed that the display module 3 is designed with a working mode of TN-LC (Twisted Nematic) Normally White. As shown in FIG. 5A and FIG. 5B, when the display module 3 displays an even numbered frame, a common voltage (such as Vcom) is applied to the first electrode layer 421 of the first substrate 42, while a second dark-state voltage is applied to the second wide electrodes 451a and a second white-state voltage (such as Vcom) is applied to the second narrow electrodes 451b of the second electrode layer 451 of the second substrate 45. In this way of electrode design and voltage application, the states of LC molecules positioned above the second wide electrodes 451a are changed, and the second wide electrodes 451a become the dark regions since no light could pass through those areas. Meanwhile, the states of LC molecules positioned above the second narrow electrodes 451b and the second gaps 453 are not changed, and the second narrow electrodes 451b and the second gaps 453 form the white regions because of light penetration through those areas. Similarly, the width of the dark region is larger than the width of the white region. In this embodiment, when the display module 3 displays the even numbered frames such as frames 2, 4, 6, . . . , etc., the barrier module 4 presents the pattern of black-and-white interlaced stripes, and the right eye (R) and left eye (L) of a viewer is able to see the appropriate images respectively on the red sub-pixel 31 and the green sub-pixel 32, or images respectively on the blue sub-pixel 33 and the red sub-pixel 31, through the barrier module 4.

Compared to the conventional 3D display, the 3D display of the embodiment has wider dark regions in the odd and even numbered frames, thereby decreasing the visible crosstalk along the x-direction of the 3D image.

As shown in FIG. 4A, a width W_{L1} of the first wide electrode 421a of the first electrode layer 42 is a first dark region width D1. A first white region width W1 is a sum of a width Wₙ₁ of the first narrow electrode 421b and widths S1 of two of the first gaps 423 of the first electrode layer 42 (e.g. W1=Wₙ₁+2×S1), wherein W1 is no more than D1 (W1≦D1). In one embodiment, a ratio of W1/(W1+D1) is in a range of 0.2-0.5. In one embodiment, W1:D1 is 3:7.

As shown in FIG. 5A, a width W_{L2} of the second wide electrode 451a of the second electrode layer 45 is a second dark region width D2. A second white region width W2 is a sum of a width Wₙ₂ of the second narrow electrode 451b and widths S2 of two of the second gaps 453 of the second electrode layer 45 (e.g. W2=Wₙ₂+2×S2), wherein W2 is no more than D2 (W2≦D2). In one embodiment, a ratio of W2/(W2+D2) is in a range of 0.2-0.5. In one embodiment, W2:D2 is 3:7.

In one embodiment, the first white region width W1 of the first electrode layer 42 is further equal to the second white region width W2 of the second electrode layer 45, and the first dark region width D1 is equal to the second dark region width D2.

Several displaying methods of the 3D display according to the embodiments are described below for demonstration. Different types of back light modules, such as flash-type BLU, scanning-type BLU, etc., could be cooperated with the aforementioned 3D display of the embodiment to achieve the 3D displaying effect. Alternatively, the 3D displaying effect is still achieved by modifying the aforementioned barrier module of the embodiment, such as showing the patterns of black-and-white interlaced stripes at different regions of the first and second substrate of the barrier module and adopting the always-on back light module for providing light to full range of the display module. The displaying methods described in details with reference to the accompanying drawings are provided for illustration, not intended to limit the 3D displaying methods of the present disclosure. The modifications and variations can be made by skilled in the art without departing from the spirit of the disclosure to meet the requirements of the practical applications.

<Displaying Method of 3D Display with Flash-Type BLU>

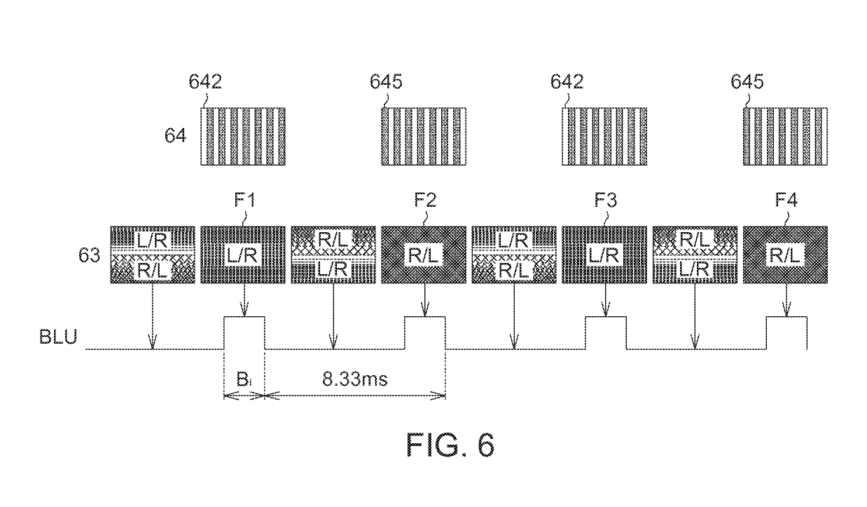

FIG. 6 illustrates a displaying method of the 3D display with a flash-type BLU according to one embodiment of the present disclosure. When an image signal is inputted into the display module 63, the back light module BLU and the barrier module 64 are turned off. When a blanking interval signal is inputted into the display module 63 in a blanking interval (i.e. the time difference between the last line of one frame of the full image display and the beginning of the first line of the next frame), the back light module BLU and the barrier module 64 are turned on to display the odd numbered frame or the even numbered frame. One example of the period of an odd or even numbered frame is 8.33 ms (f=120 Hz). As show in FIG. 6, when the display module 63 displays the odd numbered frame F1 (or F3) in the blanking interval, the back light module BLU is turned on and the barrier module 64 presents the pattern of white-and-black interlaced stripes. When the display module 63 displays the even numbered frame F2 (or F4) in the next blanking interval, the back light module BLU is turned on and the barrier module 64 presents the pattern of black-and-white interlaced stripes (which is different from the pattern presented in the previous blanking interval). Therefore, the left eye and right eye of a viewer are able to see the images on the different sub-pixels (i.e. for showing the L and R images to the left eye and the right eye) when the display module 63 displays the odd and even numbered frames.

<Displaying Method of 3D Display with Scanning-Type BLU>

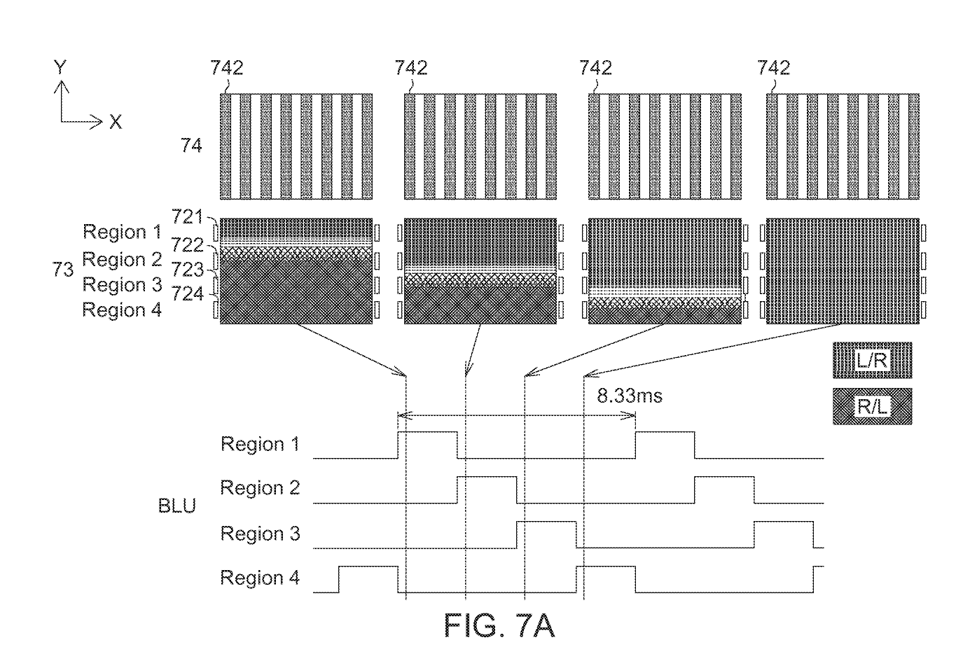

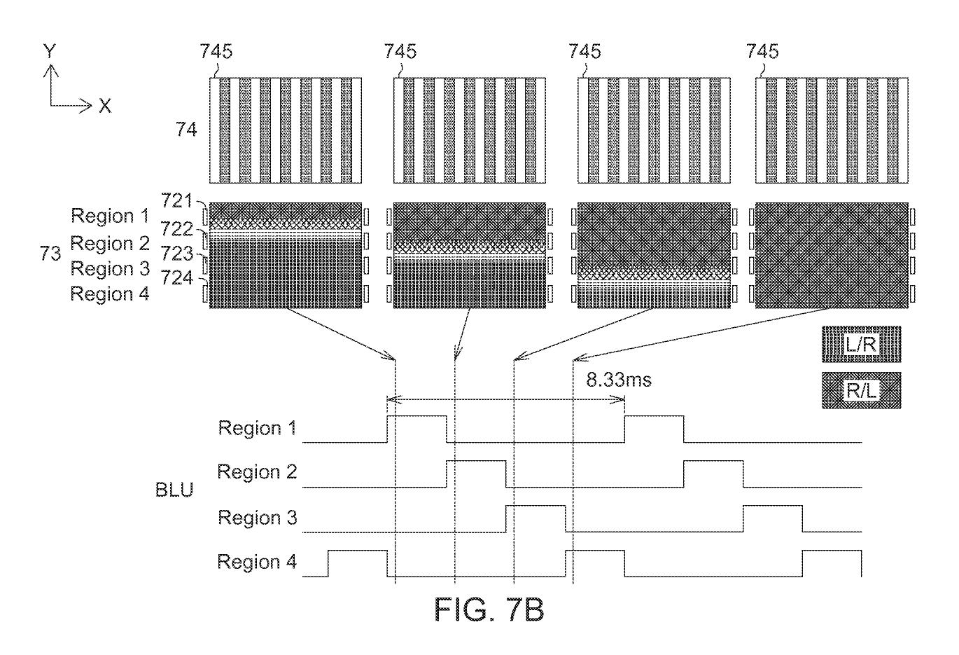

FIG. 7A and FIG. 7B illustrate a displaying method of the 3D display with a scanning-type BLU in one odd numbered frame and one even numbered frame according to a further embodiment of the present disclosure, respectively. In this embodiment, the display module could be divided into m of displaying regions (m≧2, m is a positive integer) and the back light module BLU includes m of light sources for respectively providing light for said m of displaying regions. As show in FIG. 7A and FIG. 7B, four of displaying regions (Region 1-Region 4) and four of BLUs (721-724) are taken for illustration.

Many different ways could be adopted for dividing the display module into several displaying regions. In this embodiment, a longitudinal extending direction (such as parallel to the x-direction) of each display region is substantially vertical to a longitudinal extending direction (such as parallel to the y-direction) of the first wide electrodes or that of the second wide electrodes of the barrier module 74.

When an image signal is inputted into one of the m of displaying regions of the display module 73 in the odd numbered frame or the even numbered frame, the light source corresponding to said one displaying region is turned on.

As shown in FIG. 7A, when the image signal is inputted into the first displaying region (Region 1) of the display module in the odd numbered frame, the first light source 721 corresponding to the Region 1 is turned on. Then, when the image signal is inputted into the second displaying region (Region 2), the second light source 722 corresponding to the Region 2 is turned on, and so on. Accordingly, when the image signals are inputted into the first displaying region to the m-th displaying region of the display module one after another, the first to the m-th light source corresponding to the first displaying region to the m-th displaying region are turned on one after another. Meanwhile, other light sources corresponding to the displaying regions in which the image signals have been inputted are turned off. Also, the barrier module 74 continuously presents the pattern of black-and-white interlaced stripes in the period of the odd numbered frame.

After the image signals corresponding to the odd numbered frame have been completely inputted, the image signals corresponding to the even numbered frame are subsequently inputted into the displaying regions of the display module and the procedures are similar to that of FIG. 7A. As shown in FIG. 7B, when the image signals corresponding to the even numbered frame are inputted into the first displaying region to the fourth displaying region (Regions 1-4) of the display module one after another, the first to the fourth light source corresponding to the Regions 1-4 are turned on one after another. In this embodiment, the display difference between the odd and even numbered frames is that the barrier module 74 continuously presents different pattern of white-and-black interlaced stripes in the period of the even numbered frame.

In this embodiment, there is substantially no interval between the time for opening the n-th light source (n<m, and n is positive integer) and the time for opening the next (i.e. (n+1)-th) light source, as shown in FIG. 7A and FIG. 7B. For example, the first light source 721 is turned off when the second light source 722 is turned on, so that the open periods of light sources are not overlapped. However, the disclosure is not limited thereto. The time for opening the n-th light source corresponding to the n-th displaying region and the time for opening the (n+1)-th light source corresponding to the (n+1)-th displaying region could be partially overlapped for increasing the brightness of display, but the time for opening the m-th light source and the time for opening the first light source are staggered.

<Displaying Method of 3D Display with Scanning-Type Barrier Module>

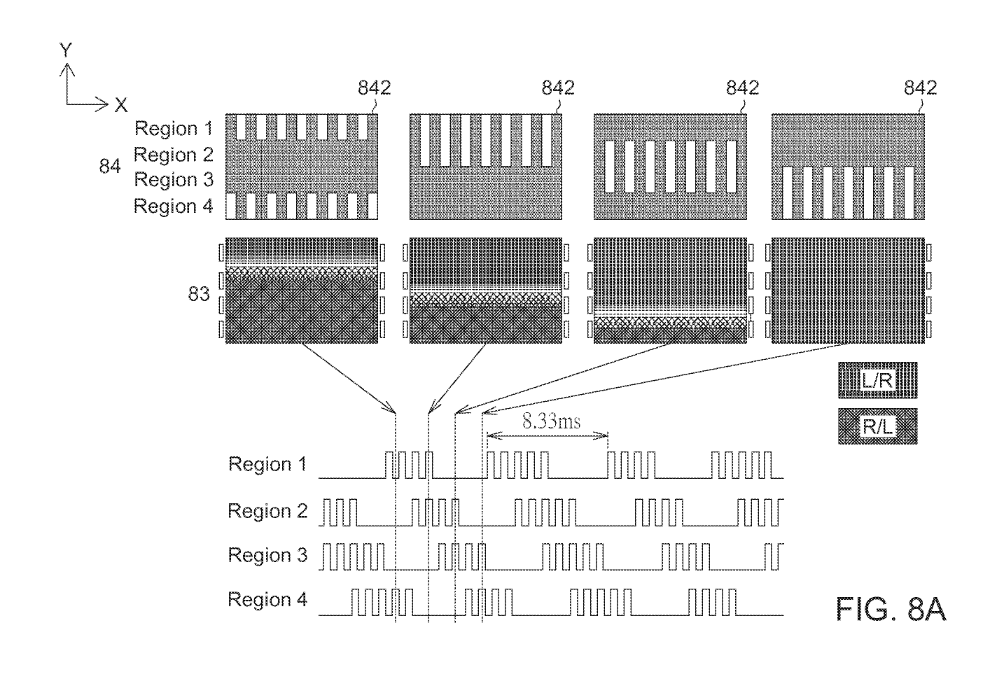

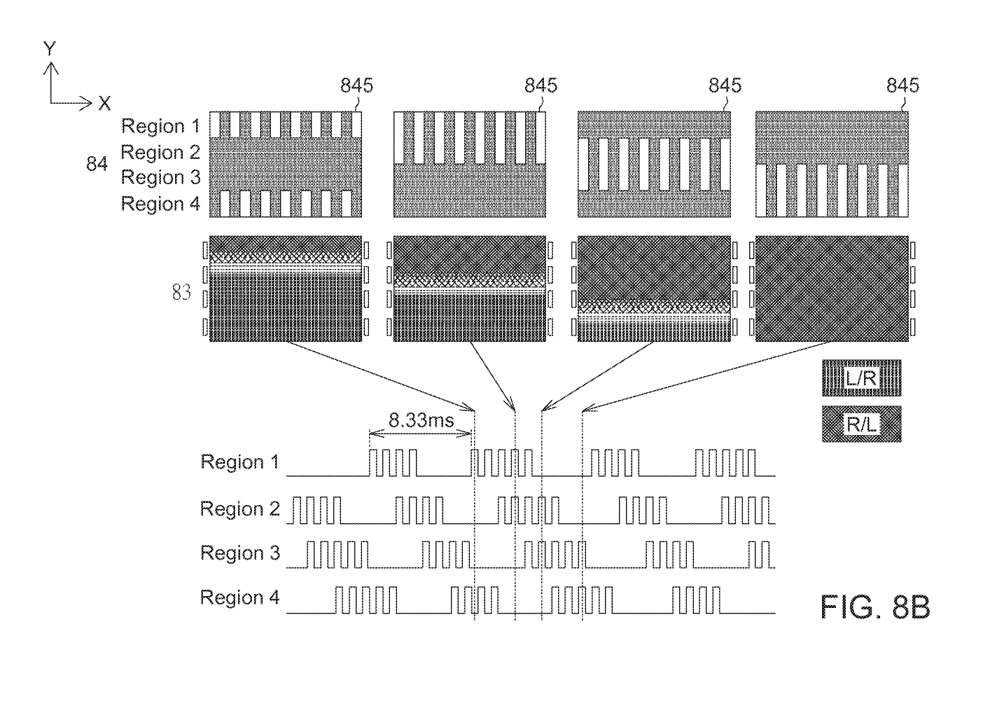

FIG. 8A and FIG. 8B illustrate a displaying method of the 3D display with a scanning-type barrier module in one odd numbered frame and one even numbered frame according to another embodiment of the present disclosure, respectively. In this embodiment, the barrier module is divided into several displaying regions, which means that each of the first electrode layer of the first substrate and the second electrode layer of the second substrate comprises independently operated m of displaying regions (m≧2, m is a positive integer). As show in FIG. 8A and FIG. 8B, four of displaying regions (Region 1-Region 4) of the barrier module 84 are taken for illustration.

In this embodiment, each display region of the first substrate of the barrier module still comprises the first wide electrodes, the first gaps and the first narrow electrodes interlaced in order; similarly, each display region of the second substrate of the barrier module still comprises the second wide electrodes, the second gaps and the second narrow electrodes interlaced in order. Accordingly, a longitudinal extending direction (such as parallel to the x-direction) of each display region is substantially vertical to a longitudinal extending direction (such as parallel to the y-direction) of the first and second wide and narrow electrodes of the barrier module 84.

When an image signal is inputted into the display module 83 in the odd numbered frame or the even numbered frame, the displaying region of the barrier module 84 corresponding to the pixel region with the image signal inputted is turned on.

As shown in FIG. 8A, when the image signal is inputted into the display module 83 in the odd numbered frame and the pixel region with the image signal inputted is corresponding to the first displaying region (Region 1) of the barrier module 84, the first displaying region (Region 1) of the barrier module 84 is turned on to present the pattern of black-and-white interlaced stripes. Next, when the image signal is inputted into the pixel region of the display module 83 which is corresponding to the second displaying region (Region 2) of the barrier module 84, the second displaying region (Region 2) of the barrier module 84 is turned on to present the pattern of black-and-white interlaced stripes. The third and fourth displaying regions (Region 3 and Region 4) of the barrier module 84 are then turned on as aforementioned procedures. Accordingly, when the image signals are subsequently inputted into the display module in the odd numbered frame, the first displaying region to the m-th displaying region of the barrier module corresponding to the pixel regions with the image signals inputted are turned on one after another. Meanwhile, other displaying regions of the barrier module corresponding to the pixel regions of the display module in which the image signals have been inputted could be turned off for not showing the black-and-white interlaced stripes, and also could be partially turned on to make two (as shown in FIG. 8A and FIG. 8B) or more of displaying regions of the barrier module in the opening condition at the same time.

After the image signals corresponding to the odd numbered frame have been completely inputted, the image signals corresponding to the even numbered frame are subsequently inputted into the pixel regions of the display module 83 and the procedures are similar to that of FIG. 8A. As shown in FIG. 8B, when the image signals corresponding to the even numbered frame are inputted into the pixel regions of the display module 83 which are corresponding to the first displaying region to the fourth displaying region (Regions 1-4) of the barrier module 84, the first displaying region to the fourth displaying region (Regions 1-4) of the barrier module 84 are turned on one after another. In this embodiment, the display difference between the odd and even numbered frames is that different substrate (e.g., the second substrate) of the barrier module 84 presents the pattern of white-and-black interlaced stripes in the period of the even numbered frame. Additionally, the back light module continuously opens during the odd and even numbered frames.

In application of the 3D display with scanning-type barrier module according to this embodiment, the time sequence of opening the displaying regions of the barrier module 84 could be arranged as staggered (e.g. the time for opening the n-th displaying region and the time for opening the (n+1)-th displaying region are substantially staggered), or partial overlapped. As shown in FIG. 8A and FIG. 8B, the time for opening the n-th displaying region and the time for opening the (n+1)-th displaying region of the barrier module are partially overlapped. When the time for opening the m-th displaying region and the time for opening the first displaying region of the barrier module are partially overlapped, the white regions of the first displaying region are positioned correspondingly to the dark regions of the m-th displaying region. As shown in FIG. 8A and FIG. 8B, the time for opening the first displaying region (Region 1) and the time for opening the second displaying region (Region 2) of the barrier module are partially overlapped, and the time for opening the second and third (Region 3) displaying regions are partially overlapped, and the time for opening the third and fourth (Region 4) displaying regions are partially overlapped. Also, the time for opening the fourth displaying region (Region 4) of the barrier module in the odd numbered frame partially overlaps the time for opening the first displaying region (Region 1) of the barrier module in the next even numbered frame (FIG. 8B); meanwhile, positions of the white regions of the first displaying region are correspondingly to that of the dark regions of the fourth displaying region (e.g. the white regions of the first and fourth displaying regions being staggered, and so as the dark regions).

According to the aforementioned description, the 3D display of the embodiment provides a barrier module including two substrates each having electrodes with different widths. In the even and odd numbered frames, the electrodes of the two substrates are also driven by the voltages as described above. Accordingly, the visible crosstalk interference along x-direction of the 3D image on the 3D display of the embodiment is effectively decreased without sacrificing the resolution of 3D display.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A three-dimensional (3D) display, comprising:
a display module;
a back light module; and
a barrier module, disposed above the display module, comprising:
a first substrate, having a first electrode layer comprising a plurality of first wide electrodes and a plurality of first narrow electrodes interlaced in order and separated by a first gap;
a second substrate, assembled to the first substrate and having a second electrode layer, and the second electrode layer comprising a plurality of second wide electrodes and a plurality of second narrow electrodes interlaced in order and separated by a second gap, wherein the second narrow electrodes of the second electrode layer are positioned correspondingly to the first wide electrodes, while the second wide electrodes of the second electrode layer are positioned correspondingly to the first narrow electrodes; and
a display material disposed between the first substrate and the second substrate.

2. The 3D display according to claim 1, wherein a first white region width W1 is the sum of one of the first narrow electrode width and two of the first gap width, and a first dark region width D1 is the first wide electrode, and the first white region width W1 is no more than the first dark region width D1 (W1≦D1).

3. The 3D display according to claim 2, wherein a second white region width W2 is the sum one of the second narrow electrode width and two of the second gap width, and a second dark region width D2 is the second wide electrode width, and the second white region width W2 is no more than the second dark region width D2 (W2≦D2).

4. The 3D display according to claim 3, wherein the first white region width W1 is equal to the second white region width W2, and the first dark region width D1 is equal to the second dark region width D2.

5. The 3D display according to claim 3, wherein a ratio of W1/(W1+D1) is in a range of 0.2 to 0.5, and a ratio of W2/(W2+D2) is in a range of 0.2 to 0.5.

6. The 3D display according to claim 1, wherein each of the first substrate and the second substrate of the barrier module comprises m displaying regions (m≧2, and m is an integer) driven independently.

7. The 3D display according to claim 6, wherein a longitudinal extending direction of the display regions is substantially vertical to a longitudinal extending direction of the first electrode and the second wide electrode.

8. The 3D display according to claim 1, wherein the display module comprises m displaying regions (m≧2, and m is an integer), and a longitudinal extending direction of the display regions is substantially vertical to a longitudinal extending direction of the first wide electrodes or the second wide electrodes.

9. The 3D display according to claim 8, wherein the back light module comprises a plurality of light sources driven independently, and the light sources provide light for the displaying regions.

10. The 3D display according to claim 1, wherein the barrier module is disposed between the display module and the back light module.

11. The 3D display according to claim 1, wherein the display module is disposed between the barrier module and the back light module.

12. A displaying method of the 3D display of claim 1, comprising:
when the display module displaying an odd numbered frame, applying a first dark-state voltage to the first wide electrodes, applying a first white-state voltage to the first narrow electrodes, and applying a common voltage to the second electrode layer;
when the display module displaying an even numbered frame, applying a second dark-state voltage to the second wide electrodes, applying a second white-state voltage to the second narrow electrodes, and applying the common voltage to the first electrode layer.

13. The displaying method according to claim 12, wherein when an image signal is inputted into the display module, the back light module and the barrier module are turned off; and when a blanking interval signal is inputted into the display module in a blanking interval, the back light module and the barrier module are turned on.

14. The displaying method according to claim 12, wherein the display module comprises m displaying regions (m≧2, m is a positive integer) and the back light module comprises m light sources for respectively providing light for said m displaying regions, and when an image signal is inputted into one of the displaying regions of the display module in the odd numbered frame or the even numbered frame, the light source corresponding to the one of the displaying regions is turned on.

15. The displaying method according to claim 14, wherein the image signals are inputted into the first displaying region to the m-th displaying region of the display module one after another, the first light source to the m-th light source corresponding to the first displaying region to the m-th displaying region are turned on one after another.

16. The displaying method according to claim 12, wherein each of the first electrode layer and the second electrode layer of the barrier module comprises independently operated m displaying regions (m≧2, m is a positive integer), and when an image signal is inputted into the display module in the odd numbered frame or the even numbered frame, the displaying region of the barrier module corresponding to the pixel region with the image signal inputted is turned on.

17. The displaying method according to claim 16, wherein when the image signals are subsequently inputted into the display module in the odd numbered frame or the even numbered frame, the first displaying region to the m-th displaying region of the barrier module corresponding to the pixel regions with the image signals inputted are turned on one after another.
